(19) United States
(12) Patent Application Publication
(10) Pub. No.: US 2018/0039479 A1
(43) Pub. Date: Feb. 8, 2018

(54) Digital Content Search and Environmental Context

(71) Applicant: Adobe Systems Incorporated, San Jose, CA (US)

(72) Inventors: Peter Raymond Fransen, Soquel, CA (US); Yuyan Song, Milpitas, CA (US); Pradhan S. Rao, Sunnyvale, CA (US)

(73) Assignee: Adobe Systems Incorporated, San Jose, CA (US)

(21) Appl. No.: 15/228,680

(22) Filed: Aug. 4, 2016

(51) Int. Cl. G06F 3/16; G06F 3/01; G06F 17/30

(52) U.S. Cl. CPC G06F 3/167; G06F 17/30554; G06F 17/30696; G06F 17/30528; G06F 3/017; G06F 3/013

(57) ABSTRACT

Digital content search and environmental context techniques and systems are described. The environmental context is leveraged to provide additional information and insight into a likely goal of a textual search query input by a user. In one example, environmental conditions are leveraged to provide a search query context. In another example, environmental conditions are detected to determine a type of object that is disposed in the physical environment of a user. From this, the computing device identifies and launches an application that corresponds to the detected type of object from an image captured of the physical environment. In a further example, the environmental context is used to refine a search in response to user selection of physical objects in a physical environment of the user.

### BACKGROUND

Search is one of the primary techniques used to locate digital content of interest. A user, for instance, may interact with a search engine over the internet to locate webpages, online videos, and so forth. Likewise, a user may initiate a search locally on a computing device to locate digital content of interest, such as songs and images.

Conventional search techniques, however, rely solely on entry of text by a user. This text is then matched with descriptions (e.g., metadata) associated with the digital content as part of the search. Consequently, these conventional search techniques are dependent on an ability of the user to express a desired result of the search using text. These conventional techniques also are dependent on reaching consensus between how a user describes a desired result of the search using text with the descriptions provided by originators of the digital content. As such, conventional search techniques may be limited in an ability to achieve an accurate search result and typically rely on refinement of a search query over multiple iterations, which is both inefficient and frustrating.

In addition, the world of augmented and virtual reality provides interesting new opportunities for immersive entertainment. Users are either interacting with the real world with digital enhancements (augmented reality) or are interacting with a wholly digital world (virtual reality). Current implementations of these experiences rely on typical text or voice web search behavior as discussed above to access digital content.

### SUMMARY

Digital content search and environmental context techniques and systems are described. The environmental context is leveraged to provide additional information and insight into a likely goal of a textual search query input by a user. In this way, accuracy of a search result is improved in an efficient manner without additional manual user input, which otherwise may be difficult to express using text in certain instances.

In one example, a user's interaction with physical objects is used to generate a search query. A user, for instance, may select a physical coffee cup “in real life.” Characteristics of the coffee cup are then used to define a search query, e.g., shape of a handle, object type (cup), material type, color, and so forth. The user may then continue to select other physical objects in order to refine this search, such as to select another physical object and have characteristics that are detected for that object supplement the search, e.g., a color of a wall. An output of the search may be performed in a variety of ways, such as virtual objects as part of an augmented or virtual reality scenario. In this way, the search query may be formed by leveraging knowledge of interaction of a user as part of a physical environment in order to launch the search.

In another example, a computing device of a user receives an input defining a text search query to locate digital content. The computing device also detects one or more environmental conditions of a physical environment in which the computing device is disposed. The environmental conditions are usable to detect potential likes and dislikes of a user in a current context of the user, such as a particular brand of object in the environment, preferred colors, and so forth.

In a further example, environmental conditions are also detected to determine a type of object that is disposed in the physical environment of a user. An image, for instance, may be captured of a physical environment, in which, the device is disposed. From this, the computing device identifies an application that corresponds to the detected type of object from an image captured of the physical environment. The computing device then launches the application, such as to enable a user to set an alarm or schedule an appointment by looking at a wall clock, check the weather by looking at an umbrella, and so forth.

In a further example, and specifically valuable in an augmented or virtual reality environment, the environmental context is used to refine a search in response to user selection of physical objects. The user, for instance, may provide a text search query via speech, manual entry, and so forth. The user may then select a physical object. Characteristics of the physical object that are relevant to the text search query are then used to provide a search query context, e.g., a shape, color, texture, and so forth. In this way, a user may leverage interaction with physical objects to further refine a search in a manner that may be difficult to perform using text alone.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 depicts a system in an example implementation showing operation of a user experience manager module of FIG. 1 as generating a search query context for use with a text search query.

FIG. 3 is a flow diagram depicting a procedure in an example implementation of generation of the search query context.

FIGS. 4 and 5 depict example implementations of detection of environmental conditions as giving context to a search.

FIG. 6 depicts a system in an example implementation showing operation of a user experience manager module of FIG. 1 as launching an application based on an environmental context

FIG. 7 is a flow diagram depicting a procedure in an example implementation in which an application is launched.

FIGS. 8 and 9 depict example implementations of detection of an object in a physical environment of a user and user interaction with the object to launch an application.

FIG. 10 depicts a system and FIG. 11 depicts a procedure in an example implementation showing operation of the user experience manager module of FIG. 1 as generating and refining a search query based on interaction with physical objects.

FIG. 12 depicts a system in an example implementation in which a search is refined based on detection of objects in a physical environment of a user.

FIG. 13 is a flow diagram depicting a procedure in an example implementation in which a search is refined based on detection of objects in a physical environment of a user.

FIG. 14 illustrates an example system including various components of an example device that can be implemented as any type of computing device as described and/or utilize with reference to FIGS. 1-13 to implement embodiments of the techniques described herein.

### DETAILED DESCRIPTION

Overview

Techniques and systems are described to support searches and provide an environmental context to a digital content search. The searches and environmental context are leveraged to provide additional information and insight into a likely goal of a search by a user and thus increase a likely accuracy of a search result in an efficient manner without additional manual user input.

In one example, a user's interaction with physical objects is used to generate and even launch a search query. The user, for instance, may touch a coffee cup. From this, the user's computing device may form a search query for coffee, cup, coffee cup, or any other logical search request based on the physical cup is launched. If there is a brand logo on the cup, the search query may include the brand. This support a search technique that is more intuitive and accurate than in current text web search environment of today. In a further embodiment, the keywords, characteristics, and so forth generated from the user interaction (e.g., touching) of the physical object can be used to drive a keyword advertising bidding process, allowing advertisers to bid to place ads if certain physical objects are touched. This provides advertisers a precise mechanism to target their ads. In this way, the search query may be formed by leveraging knowledge of interaction of a user as part of a physical environment, further discussion of which may be found in relation to FIGS. 10-11 in the following.

In another example, a computing device of a user receives an input defining a text search query to locate digital content, such as a search of “people talking together” for a digital image. The computing device also detects one or more environmental conditions of a physical environment in which the computing device is disposed. The environmental conditions, for instance, may describe objects surrounding the device, colors of the objects, types of objects, and so forth. These environmental conditions are usable to detect potential likes and dislikes of a user in a current context of the user, such as a particular brand of object in the environment, preferred colors, and so forth.

Further, these environmental conditions may be used to infer other environmental conditions, such as a room type (e.g., living room, bedroom), whether in a home or work environment, and so forth. Accordingly, the detected environmental conditions provide a search query context to the text search query that may give additional insight into a likely goal of a user in initiating the search.

Continuing with the previous example, the search query context may be used determine that the computing device is likely disposed within a work environment, e.g., through detection of chairs, a desk, and a company logo on a wall. The search query context, along with the text search query for “people talking together” is then used in a search to locate digital images of people talking together that is suitable for a work environment, e.g., talking around a conference table. In this way, the search result has a greater likelihood of being accurate than a search performed without such a context. Further, the search results may also change dynamically as the search query context changes, even for a matching text search query, such as to return digital images in an informal setting when the user is disposed at a home environment in the previous example. Further discussion of use of a search query context involving environmental conditions along with a text search query is described in the following in relation to FIGS. 2-5.

In a further example, environmental conditions are also detected to determine a type of object that is disposed in the physical environment of a user. A user, for instance, may wear a headset (e.g., supporting virtual reality or augmented reality), view a mobile device such as a phone or tablet, wear a wearable computing device, or other computing device configuration. Regardless of configuration, the computing device is configured to capture a digital image of the physical environment, in which, the device is disposed. From this digital image, the device detects an object that is included in the physical environment, along with user interaction involving this object.

A user, for instance, may view a physical clock mounted on a wall in a physical environment of the user. The user may gaze at the wall clock for over a threshold amount of time, make a verbal utterance (e.g., schedule an appointment), make a gesture detectable in a natural user interface (e.g., appear to grab one of the hands of the clock), physically touch the clock, and so forth. From this, the computing device identifies an application that corresponds to the detected type of object from an image captured of the physical environment.

The computing device then launches the application, such as to enable a user to set an alarm, schedule an appointment, and so forth in this example. Further, in an instance of a gesture, the gesture may continue to initiate an operation of the launched application, e.g., to change a time of an appointment. In this way, objects in a physical environment of a user may act as cues to guide and predict future user interaction with the computing device. Further discussion of these and other examples of application launch is described in the following in relation to FIGS. 6-9.

In a further example, the environmental context is used to refine a search in response to user selection of physical objects in a physical environment of the user. The user, for instance, may provide a text search query “stainless steel refrigerator” via a spoken utterance, typed on a keyboard, and so forth. The user may then select a physical object, such as a door handle of a refrigerator at an appliance store. Characteristics of the door handle that are relevant to the text search query are then used to provide a search query context, e.g., a shape of the handle, color, and so forth. In this way, a user may leverage interaction with physical objects to further refine a search in a manner that may be difficult to perform using text alone, e.g., to describe the shape of the handle. Further discussion of these and other examples of application launch is described in the following in relation to FIGS. 12-13.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

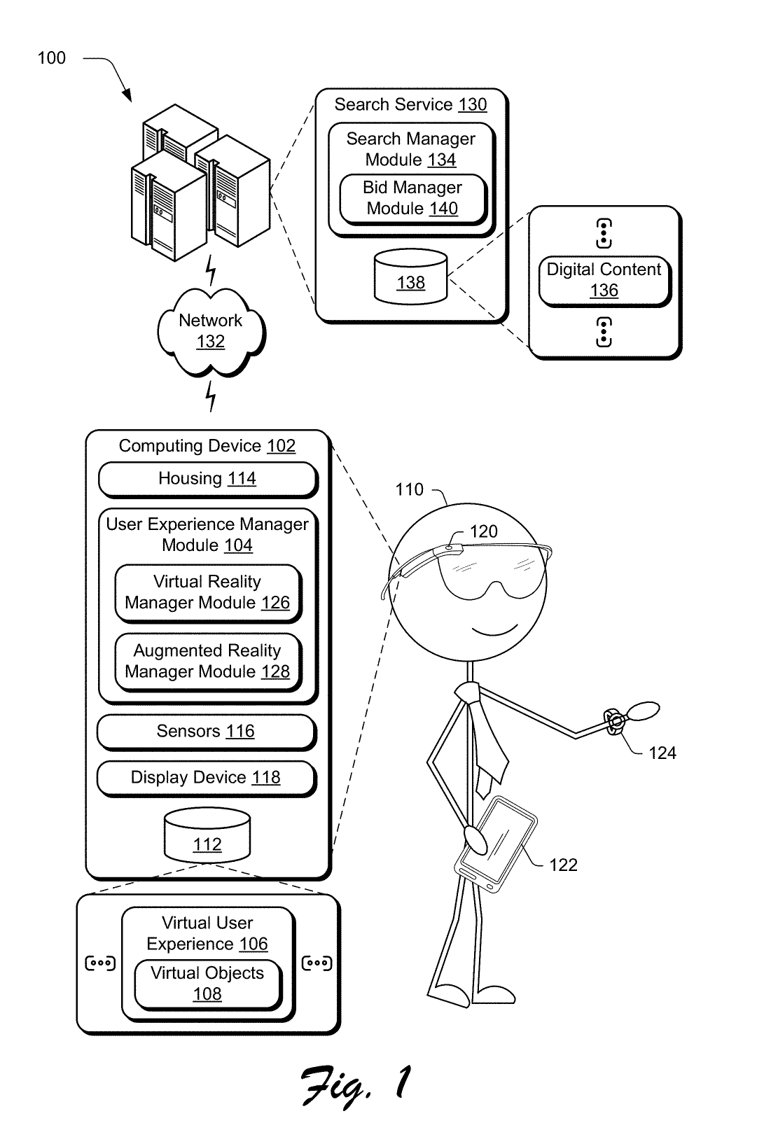

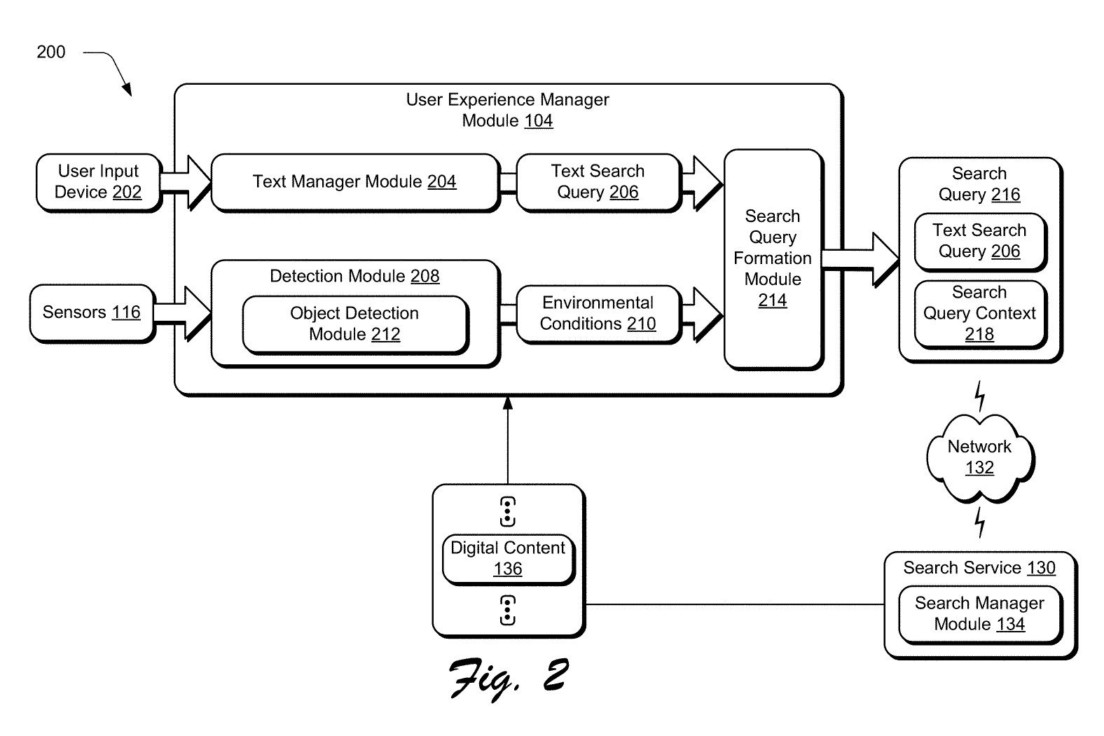

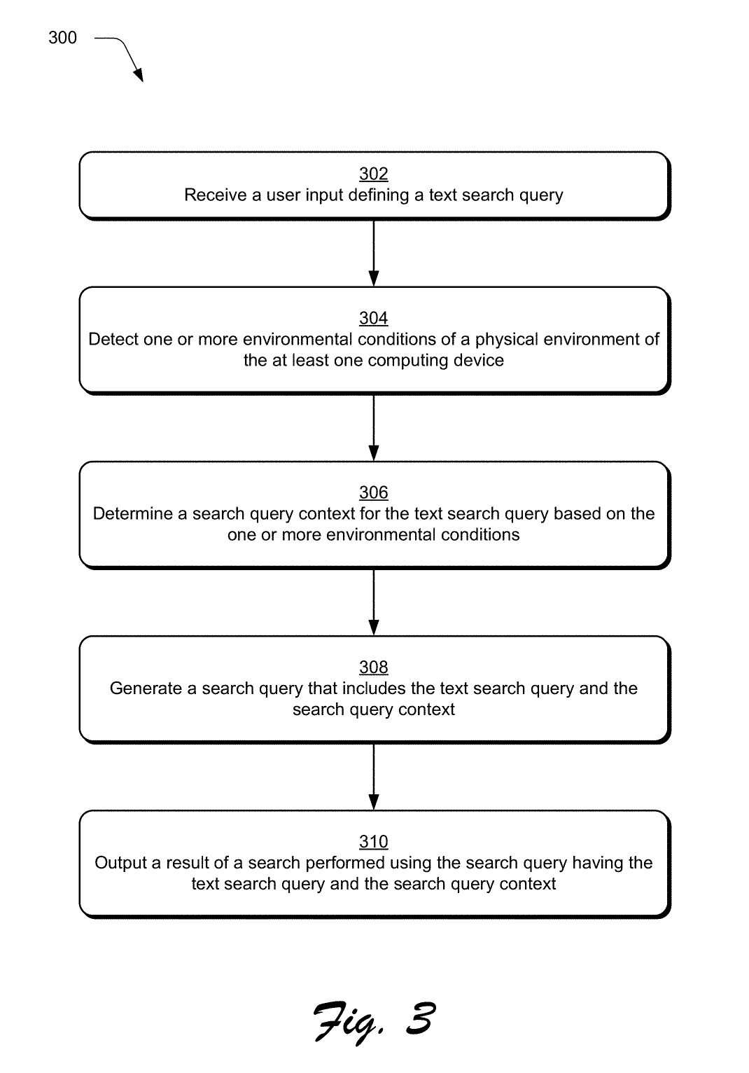

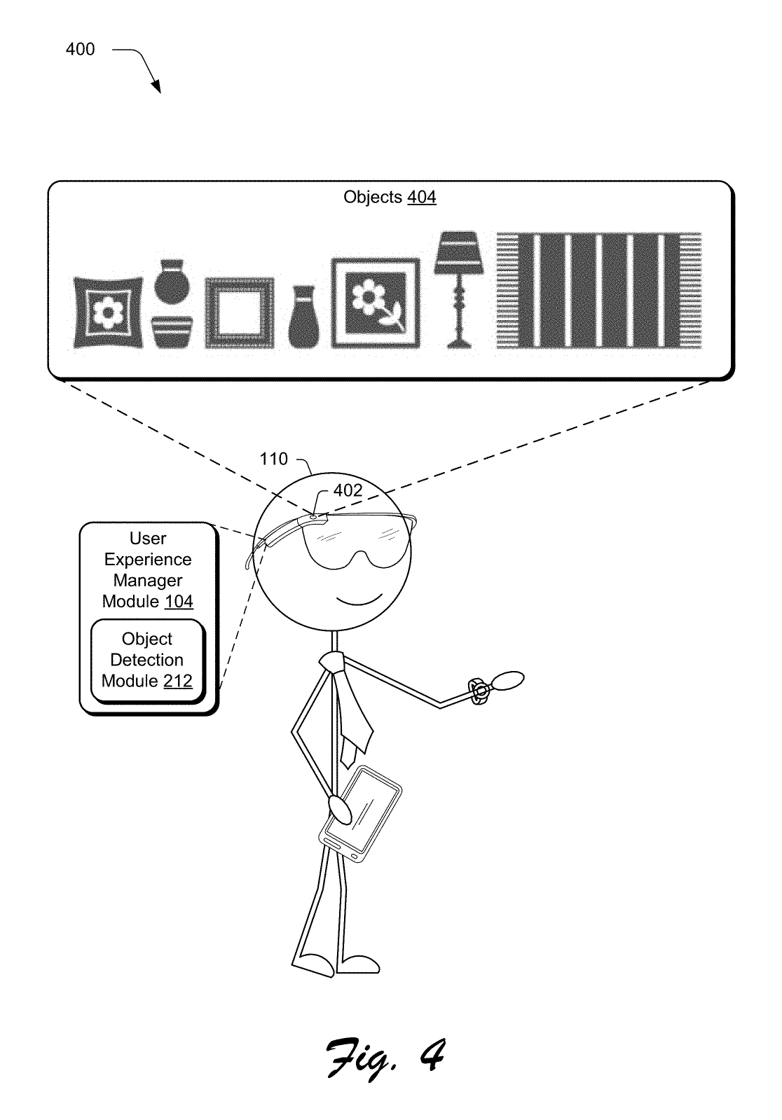

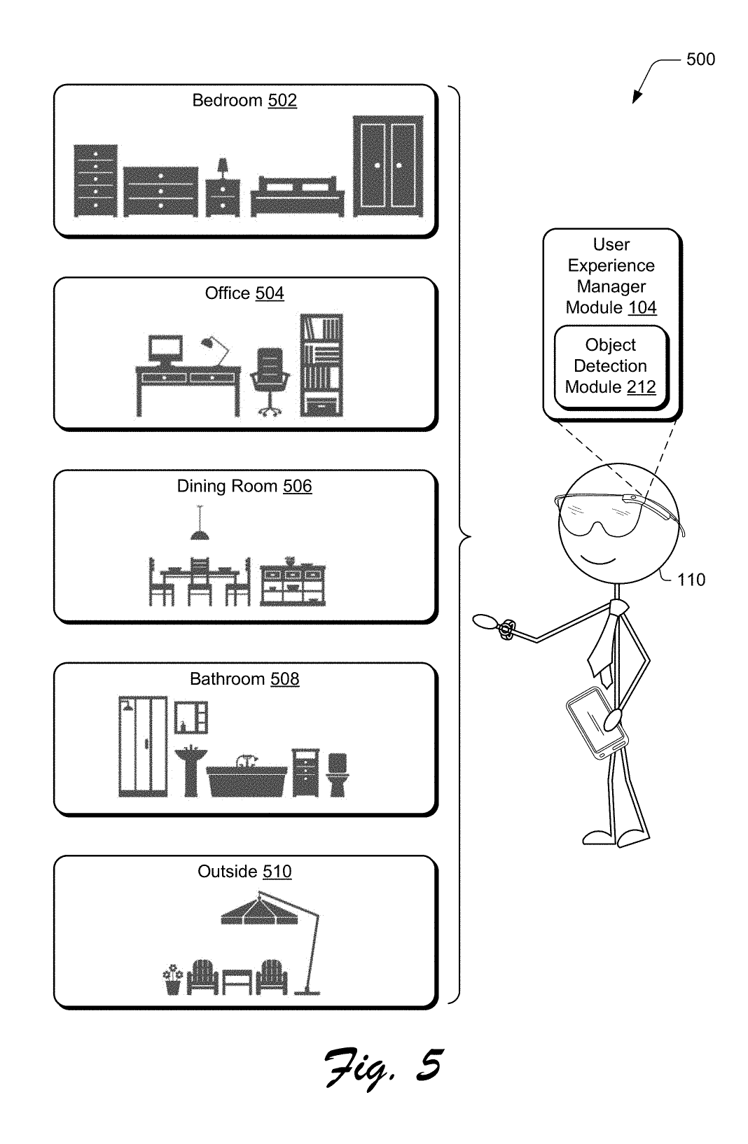

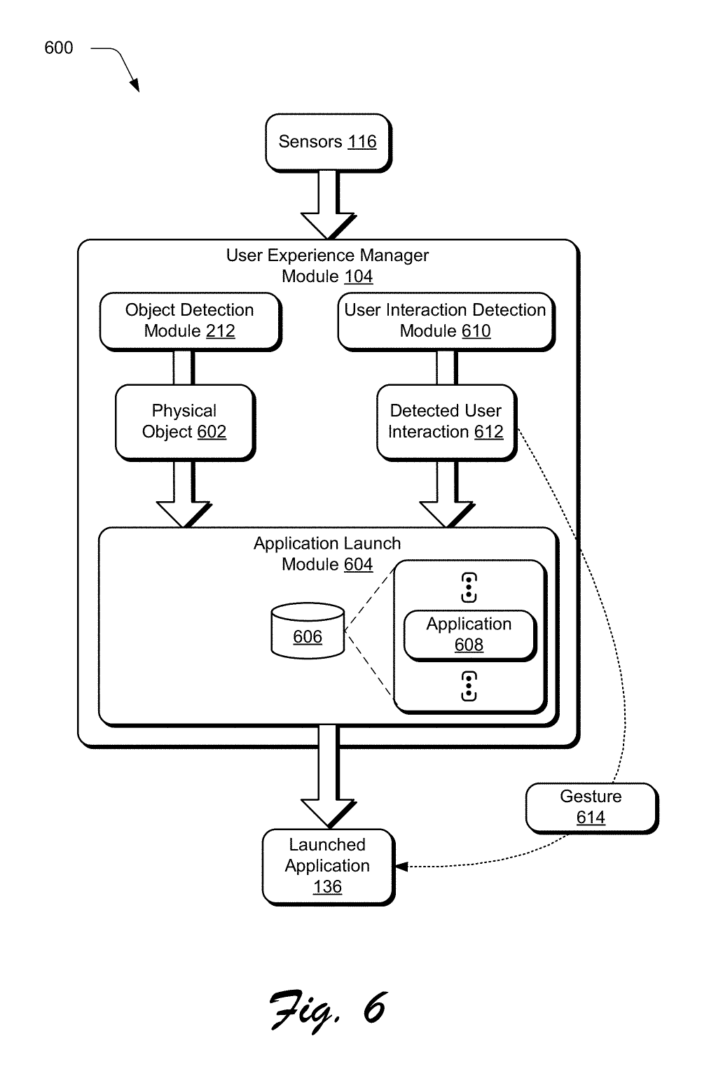

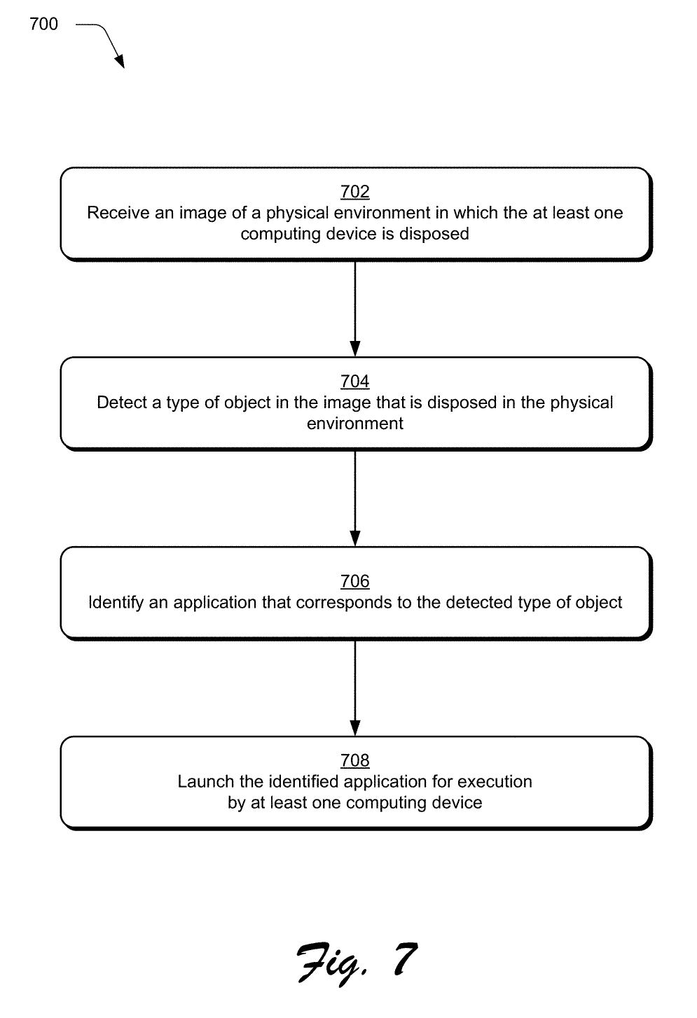

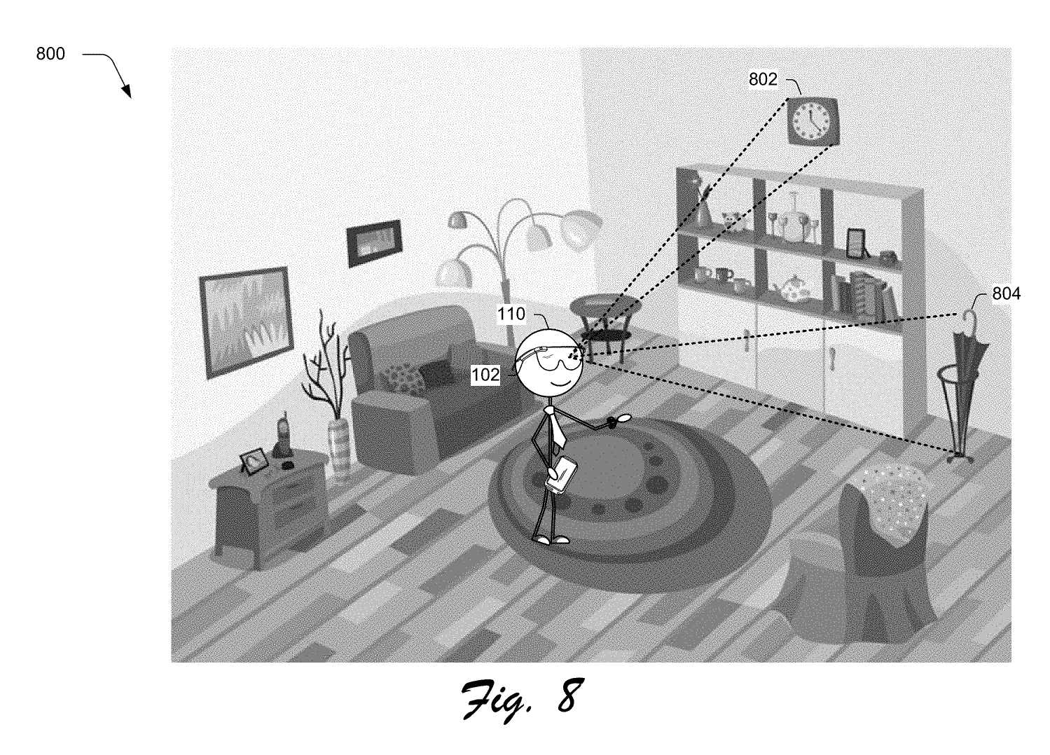

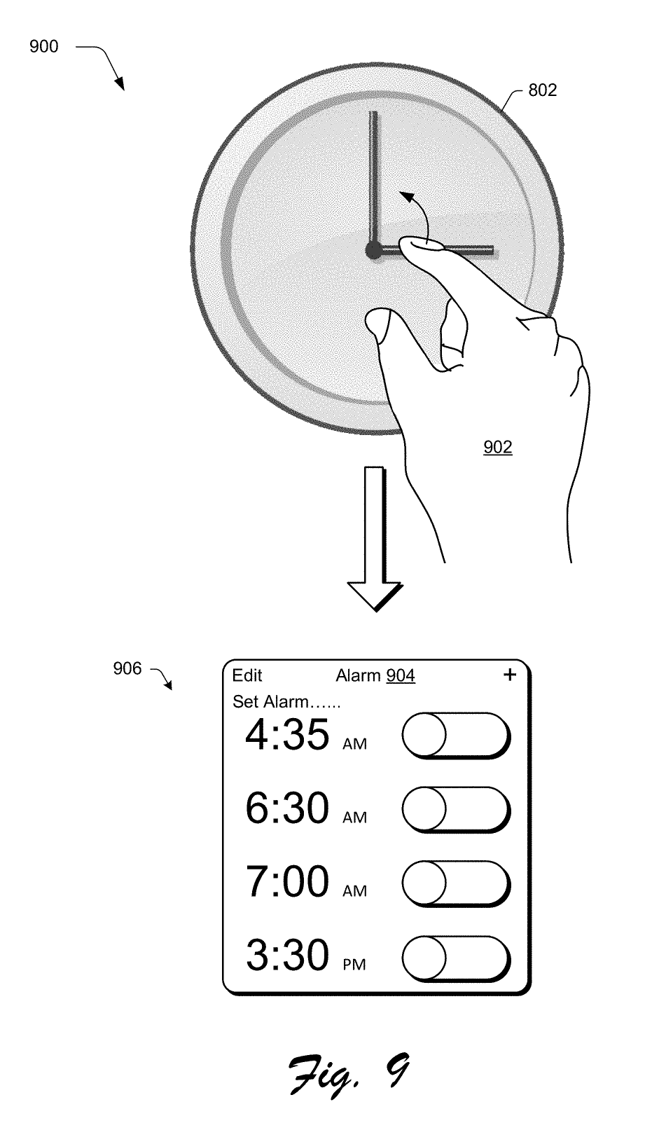

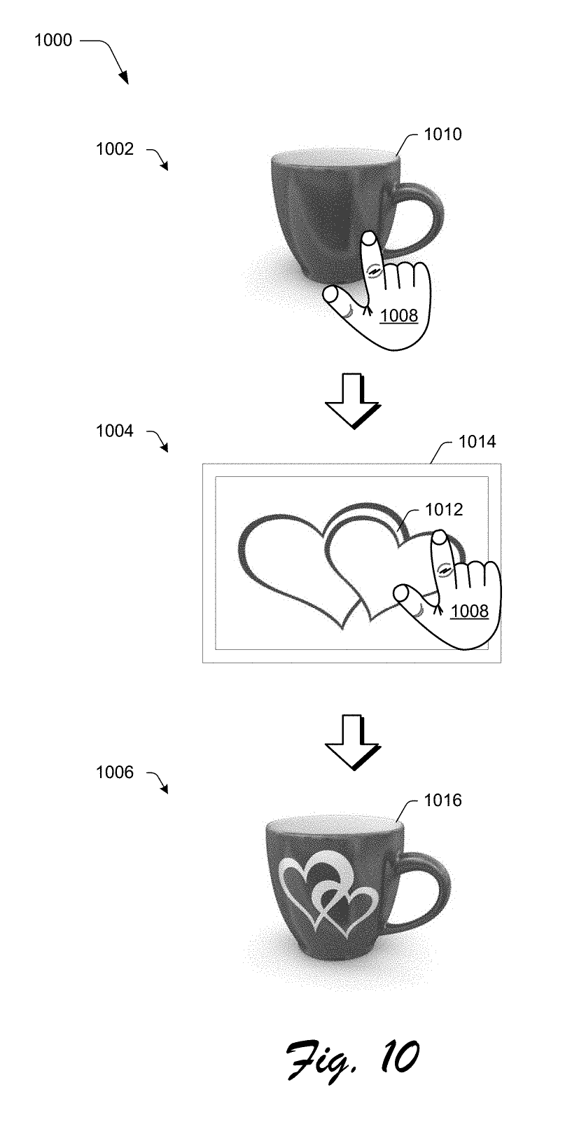

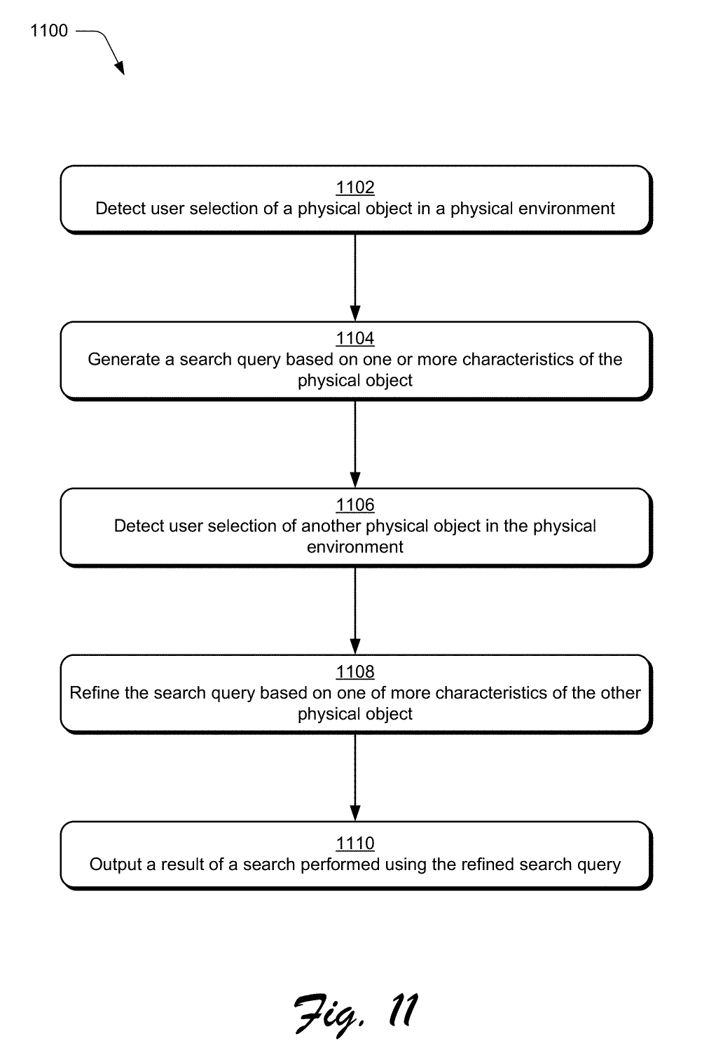

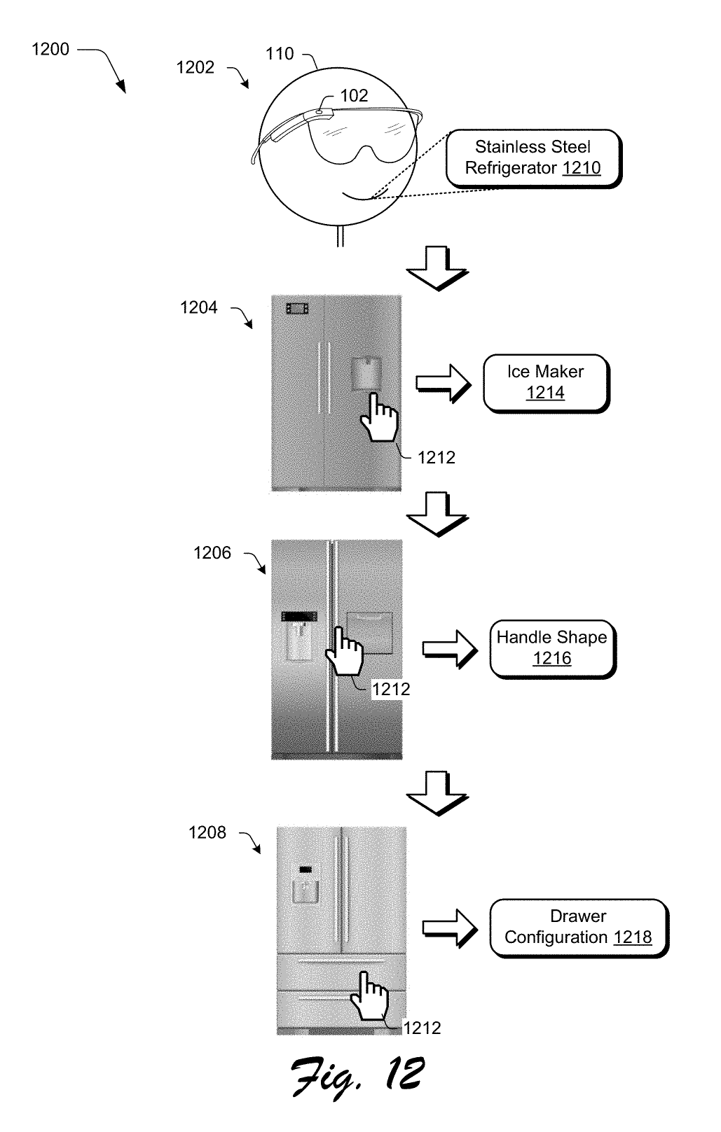

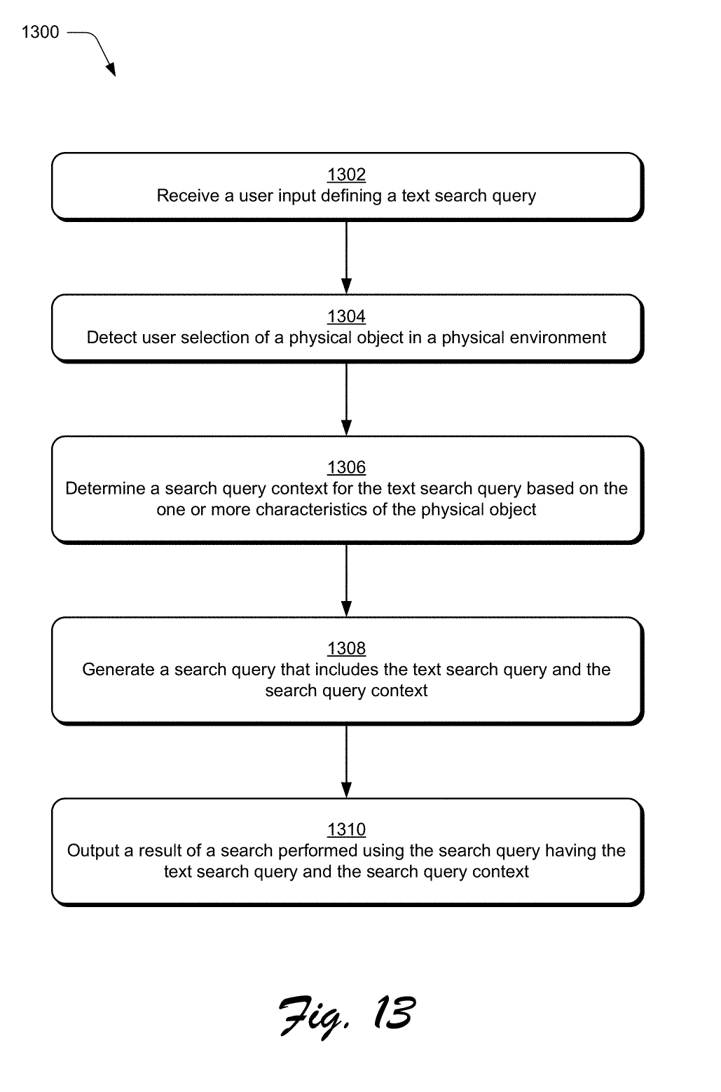

FIG. 1 is an illustration of an environment 100 in an example implementation that is operable to employ techniques described herein. The illustrated environment 100 includes a computing device 102 configured for use in augmented reality and/or virtual reality scenarios, which may be configured in a variety of ways.

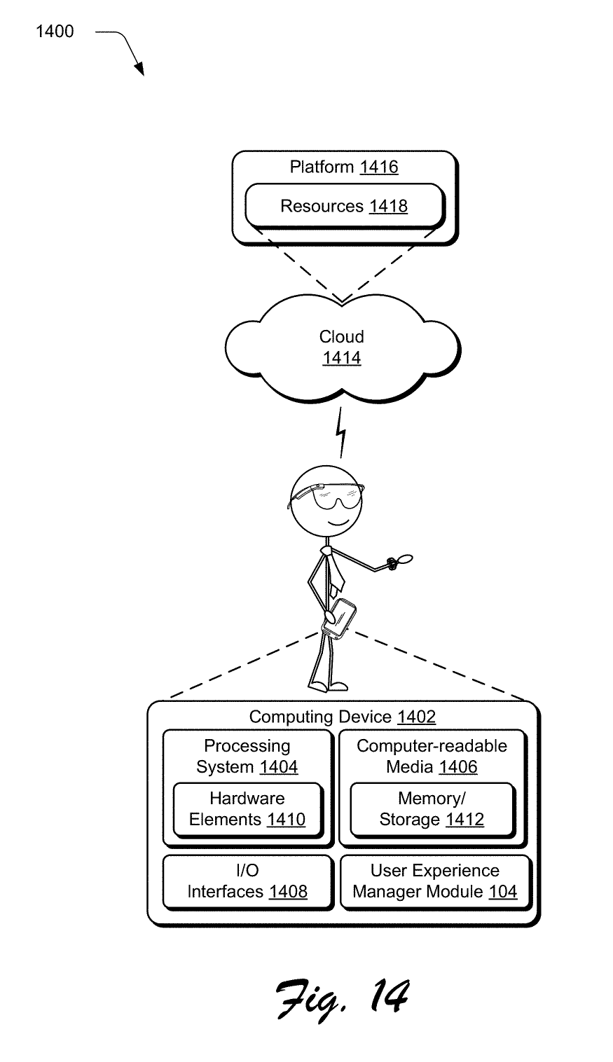

The computing device 102 is illustrated as including a user experience manager module 104 that is implemented at least partially in hardware of the computing device 102, e.g., a processing system and memory of the computing device as further described in relation to FIG. 14. The user experience manager module 104 is configured to manage output of and user interaction with a virtual user experience 106 having one or more virtual objects 108 that are made visible to a user 110. The virtual user experience 106 and one or more virtual objects 108 are illustrated as maintained in storage 112 of the computing device 102.

The computing device 102 includes a housing 114, one or more sensors 116, and a display device 118. The housing 114 is configurable in a variety of ways to support interaction with the virtual user experience 106. In one example, the housing 114 is configured to be worn on the head of a user 110 (i.e., is “head mounted” 120), such as through configuration as goggles, glasses, contact lens, and so forth. In another example, the housing 114 assumes a hand-held 122 form factor, such as a mobile phone, tablet, portable gaming device, and so on. In yet another example, the housing 114 assumes a wearable 124 form factor that is configured to be worn by the user 110, such as a watch, broach, pendant, or ring. Other configurations are also contemplated, such as configurations in which the computing device 102 is disposed in a physical environment apart from the user 110, e.g., as a “smart mirror,” wall-mounted projector, television (e.g., a series of curved screens arranged in a semicircular fashion), and so on.

The sensors 116 may also be configured in a variety of ways to detect a variety of different conditions. In one example, the sensors 116 are configured to detect an orientation of the computing device 102 in three dimensional space, such as through use of accelerometers, magnetometers, inertial devices, radar devices, and so forth. In another example, the sensors 116 are configured to detect environmental conditions of a physical environment in which the computing device 102 is disposed, such as objects, distances to the objects, motion, colors, and so forth. Examples of which include cameras, radar devices, light detection sensors (e.g., IR and UV sensors), time of flight cameras, structured light grid arrays, barometric pressure, altimeters, temperature gauges, compasses, geographic positioning systems (e.g., GPS), and so forth. In a further example, the sensors 116 are configured to detect environmental conditions involving the user 110, e.g., heart rate, temperature, movement, and other biometrics.

The display device 118 is also configurable in a variety of ways to support the virtual user experience 106. Example of which include a typical display device found on a mobile device such as a camera or tablet computer, a light field display for use on a head mounted display in which a user may see through portions of the display, stereoscopic displays, projectors, and so forth. Other hardware components may also be included as part of the computing device 102, including devices configured to provide user feedback such as haptic responses, sounds, and so forth.

The housing 114, sensors 116, and display device 118 are also configurable to support different types of virtual user experiences 106 by the user experience manager module 104. In one example, a virtual reality manager module 126 is employed to support virtual reality. In virtual reality, a user is exposed to an immersive environment, the viewable portions of which are entirely generated by the computing device 102. In other words, everything that is seen by the user 110 is rendered and displayed by the display device 118 through use of the virtual reality manager module 126.

The user, for instance, may be exposed to virtual objects 108 that are not “really there” (e.g., virtual bricks) and are displayed for viewing by the user in an environment that also is completely computer generated. The computer-generated environment may also include representations of physical objects included in a physical environment of the user 110, e.g., a virtual table that is rendered for viewing by the user 110 to mimic an actual physical table in the environment detected using the sensors 116. On this virtual table, the virtual reality manager module 126 may also dispose virtual objects 108 that are not physically located in the physical environment of the user 110, e.g., the virtual bricks as part of a virtual playset. In this way, although an entirely of the display being presented to the user 110 is computer generated, the virtual reality manager module 126 may represent physical objects as well virtual objects 108 within the display.

The user experience manager module 104 is also illustrated as supporting an augmented reality manager module 128. In augmented reality, the virtual objects 108 are used to augment a direct view of a physical environment of the user 110. The augmented reality manger module 128, for instance, may detect landmarks of the physical table disposed in the physical environment of the computing device 102 through use of the sensors 116, e.g., object recognition. Based on these landmarks, the augmented reality manager module 128 configures a virtual object 108 of the virtual bricks to appear as is placed on the physical table.

The user 110, for instance, may view the actual physical environment through head-mounted 120 goggles. The head-mounted 120 goggles do not recreate portions of the physical environment as virtual representations as in the VR scenario above, but rather permit the user 110 to directly view the physical environment without recreating the environment. The virtual objects 108 are then displayed by the display device 118 to appear as disposed within this physical environment. Thus, in augmented reality the virtual objects 108 augment what is “actually seen” by the user 110 in the physical environment. In the following discussion, the virtual user experience 106 and virtual objects 108 of the user experience manager module 104 may be used in both a virtual reality scenario and an augmented reality scenario.

The environment 100 is further illustrated as including a search service 130 that is accessible to the computing device 102 via a network 132, e.g., the Internet. The search service 130 includes a search manager module 134 that is implemented at least partially in hardware of a computing device (e.g., one or more servers) to search digital content 136, which is illustrated as stored in storage 136. Other examples are also contemplated, such as to search digital content 136 located elsewhere other than the search service 130 (e.g., webpages), implemented locally at the computing device 102 (e.g., to locate digital content 136 such as songs, videos, digital images), and so forth.

As previously described, digital content search is one of the primary techniques by which a user 110 locates digital content of interest. For instance, rather than manually navigate through a hierarchy of folders or webpages to locate a particular song of interest, a user may input a text search query (e.g., a name of the song) to locate the song. While this technique may achieve accurate and efficient results when searching for objects having names that are known to the user (e.g., the song “Happy Birthday”), these techniques are challenged in other situations in which the proper name is not known to the user or if more abstract concepts are wished to be conveyed.

Accordingly, in such situations, interaction of the user 110 with physical objects may be used to generate, launch, and refine a search query. in order to locate the digital content of interest as described in relation to FIGS. 10-14. The user experience manager module 104 is also configured to determine a search query context, which may be used to supplement the search query in order to improve accuracy of the search as further described in relation to FIGS. 2-5. Additionally, the user experience manager module 104 may also leverage knowledge of environmental conditions involving user interaction with a physical environment to launch applications, further discussion of which may be found in relation to a discussion of FIGS. 6-9.

A bid process may also be incorporated as part of the search service 130 such that entities (e.g., advertisers) may bid on opportunities to include respective virtual user experiences 106 and/or virtual objects 108 as part of a digital content 136 of a search result. Functionality of the bid process is represented as implemented at least partially in hardware by a bid manager module 140. Advertisers, for instance, may bid on opportunities to include items of digital content 136, virtual objects 108, and virtual user experiences 106 as part of a search result. This may include bidding on textual words, characteristics of physical object with which the user has interacted, environmental contexts used to refine the search, and so forth as further described in relation to FIGS. 10-11. In this way, the search service 130 may collect revenue by exposing a user interface, via which, bids may be collected and used to control dissemination of digital content.

The search service 130 may then control generation of search results based at least in part on these bids. Thus, bid techniques of the bid manager module 140 may be incorporated as part of any of the search techniques and supporting context of these search techniques that are described in the following. This includes physical interactions used to launch a search, used to refine a search, environmental conditions associated alone with a search query, characteristics of physical objects used as a basis of the search, and so forth.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Environmental Context to Supplement a Search of Digital Content

FIG. 2 depicts a system 200 in an example implementation showing operation of the user experience manager module 104 of FIG. 1 as generating a search query context for use with a search query. FIG. 3 depicts a procedure 300 in an example implementation of generation of the search query context. FIGS. 4 and 5 depict example implementations 400, 500 of determinations of search query contexts from a physical environment in which a computing device is disposed.

The following discussion describes techniques that may be implemented utilizing the described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 2-5.

In this example, a user input is received that defines a text search query (block 302). The user 110, for instance, may interact with a user input device 202 to provide inputs that are received by a text manager module 204 to form a text search query 206. The text may be received directly or determined indirectly by the text manager module 204. In a direct example, the user 110 inputs the text through use of a user input device 202 configured as a keyboard. In an indirect example, an utterance 110 of the user 110 is converted to text by the text manager module 204, e.g., using speech-to-text functionality. Other examples are also contemplated, such as to define and launch the search query based solely on user interaction with physical objects, an example of which is further described in relation to FIGS. 10-11.

One or more environmental conditions are also detected of a physical environment of the at least one computing device (block 304). Sensors 116 of the computing device 102, for instance, may provide signals to a detection module 208 to detect environmental conditions 210 that are to give a context to the text search query 206. The detection module 208, for instance, may detect the environmental conditions 210 in response to receipt of the user input specifying the text search query 206. The environmental conditions 210 may describe a variety of aspects of a physical environment, in which, the computing device 102 is disposed. Examples of such conditions include what objects are located in the physical environment through use of an object detection module 212, a type of environment, actions performed by the user 110, and so forth.

As shown in an example implementation 400 of FIG. 4, for instance, a camera 402 of the computing device 102 is forward facing and used to capture images of objects 404 in a physical environment of a user 110. An object detection module 212 is then used to detect objects from the images, such as through use of a classifier trained using machine learning. Illustrated examples include detection of household items in an environment of a user, such as pillows, vases, art, lamps, rugs, and so forth. The object detection module 212 may also be used to detect characteristics of these objects, such as colors, textures, brands, features, and so on.

Detection of these objects 404 is also usable to infer other characteristics of a physical environment of the user 110. As shown in an example implementation 500 of FIG. 5, for instance, objects are used to detect a type of room in which the user 110 is disposed. A bedroom 502, for instance, may be inferred from objects including a bed, dresser, wardrobe, and so forth. An office 504, on the other hand, is inferred from objects such as a desk and chair, computer, lamp, and bookcase. Similar techniques are usable to infer a dining room 506 from a dinner table, bathroom 508 from a sink, and whether the user is outside 510. Other examples of inferences include whether the user 110 is at a home or work environment. Accordingly, the detected objects and inferences that may be learned from these objects may be used to give context to a text search query.

Returning again to FIGS. 2 and 3, a search query context is determined for the text search query based on the one or more environmental conditions (block 306). A search query is then generated that includes the text search query and the search query context (block 308). For example, these environmental conditions 210 are then used by a search query formation module 214 to form a search query 216 having the text search query 206 and a search query context 218 for the text.

In one example, the search query formation module 214 is configured to determine relevancy of the environmental conditions 210 to the text search query 206. In a text search for home goods, for instance, objects that are relevant to that text include home goods in the user's physical environment as well as characteristics of those goods, e.g., colors, patterns, textures, and so forth. In a search for music to be played, relevancy may include whether the user 110 is at home or at work. Thus, in this example, the relevancy of the environmental conditions 210 may be based on the text search query 206 and also a type of digital content being searched.

In the illustrated example of FIG. 2, the search query formation module 214 forms the search query 216 to include the text search query 206 as well as the determined search query context 218. This is communicated over a network 132 to a search service 130 and used to perform a search. Digital content 136 resulting from the search (e.g., ordered search results, songs, images, and so forth) is communicated back to the user experience manager module 104 via the network 132. A result is then output of a search performed using the search query having the text search query and the search query context (block 310), e.g., displayed in user interface of the computing device 102. This includes output as one or more virtual objects 108 as part of a virtual reality scenario or an augmented reality scenario.

A variety of implementation scenarios may be supported by leveraging knowledge of environmental conditions to give context to a text search query. The user experience module 104, for instance, may detect a number of objects of a particular type over a threshold amount. For example, the user 110 may walk around a store and look at a display of different types of kitchen appliances. The user experience manager module 104 may thus infer that the user is located in a store and has exhibited interest in these objects. Accordingly, a text search input received at that time has a likelihood of being related to those objects. The search query context 218 may then be leveraged to address this likelihood, such as to promote search results that pertain to reviews or comparisons of the objects. Similar techniques may be used to promote search results for brands that are found in the user's 110 house or workplace environment.

Environmental Context and Application Launch

FIG. 6 depicts a system 600 and FIG. 7 depicts a procedure 700 in an example implementation showing operation of the user experience manager module 104 of FIG. 1 as launching an application based on an environmental context. FIGS. 8 and 9 depict example implementations of detection of an object in a physical environment of a user and user interaction with the object to launch an application.

The following discussion describes techniques that may be implemented utilizing the described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 6-9.

To begin, an image is received of a physical environment in which the at least one computing device is disposed (block 702). A user 110, for instance, may gaze at a physical object in the physical environment for at least a predetermined amount of time. In response, sensors 116 (e.g., a camera) of the computing device 102 are used to capture an image of the physical environment. As shown in FIG. 8, for instance, a user 110 may gaze at a physical clock 802 for a predetermined amount of time, which causes the computing device 102 to capture an image of the clock 802. Likewise, a user may gaze at an umbrella 804, which causes capture of an image of the umbrella 804. The images may also be captured in response to a user input, e.g., a button press, gesture, and so forth.

A type of object is detected in the image that is disposed in the physical environment (block 704). As previously described, an object detection module 212 employs one or more classifiers that are trained using machine learning to recognize objects included in the image. Through use of these classifiers, the object detection module 212 identifies a type of the physical object 602 from the image. Accordingly, identification of the type of physical object may be used for an arbitrary object of that type. For example, recognition of the type of physical object (e.g., clock or umbrella) may be used for any arbitrary object having that type, and thus is not limited to particular instances of those objects, e.g., a particular brand of object.

An application is identified that corresponds to the detected type of object (block 706). The user experience manager module 104, for instance, may maintain an index of applications as corresponding to particular physical objects 602, e.g., a timer application for the clock 802, a weather application for the umbrella 804, and so forth. The identified application is launched for execution by the at least one computing device (block 708). Thus, in this example, the user experience manager module 104 is configured to launch applications based on physical objects 602 that are disposed in the user's physical environment. This may also be combined with detected user interactions.

The user experience module 104, for instance, may include a user interaction detection module 610 that is implemented at least partially in hardware to detect user interaction 612 involving the physical objects 602. A variety of different user interactions may be detected. In the previous example, for instance, a detected user's gaze over a threshold amount of time is used to initiate detection of the physical object 602 by the object detection module 212.

In another example, the detected user interaction 612 may involve a gesture 614 to initiate an operation of the launched application 136. As shown in FIG. 9, for instance, a finger of a user's hand 902 is recognized as performing a gesture that mimics movement of a hand of the physical clock 802. In response, the user experience manager module 104 launches an application corresponding to the clock, e.g., an alarm application 904 in this instance. Thus, in this example a combination of the gesture and detection of the physical object is used to launch the application.

The user experience manager module 104 is also configured to initiate an operation of the launched application that corresponds to the gesture. In this example, the operation involves setting 906 an alarm as recognized by the mimicked motion relative to the hands of the clock 802. This gesture is recognized without involving actual contact with the clock 802, e.g., in a natural user interface. Other examples are also contemplated, such as the “grab the umbrella” 804 to launch output of the weather application to obtain a weather forecast at a current location of the user.

Search Query Generation and Launch

FIG. 10 depicts a system 1000 and FIG. 11 depicts a procedure 1100 in an example implementation showing operation of the user experience manager module 104 of FIG. 1 as generating and refining a search query based on interaction with physical objects. The procedure 1100 may be implemented by a variety of different systems, such as the system 200 of FIG. 2. The system 1000 is illustrated using first, second, and third stages 1002, 1004, 1006.

The following discussion describes techniques that may be implemented utilizing the described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 2, 10-11.

To begin, user selection is detected of a physical object in a physical environment (block 1102). The computing device 102, for instance, may use sensors 116 such as a camera, radar techniques, and so forth to detect that a user has interacted with a physical object. This may include specific gestures made by the user 110 in order to initiate the selection, use of a threshold amount of time over which selection of the object is deemed to have been made by the computing device 102 (e.g., an amount of time looking at the physical object), and so forth.

In response, a search query is generated based on one or more characteristics of the physical object (block 1104). The search query may be text based, employ an image captured of the object (e.g., as part of an image similarity determination performed using machine learning), and so forth. As shown at the first stage 1002 of FIG. 10, for instance, a hand 1008 of the user 110 is used to tap a coffee mug 1010. This tap is detected using sensors 116 of the computing device 102. In response, the computing device 102 collects data describing characteristics of the physical object, i.e., the coffee mug 1010. These characteristics may include a type of object (e.g., using object recognition of a digital image captured of the mug), color of the object, shape of the object, textures, positioning of the object, an environment in which the object is disposed, and so forth. From this, the search query is generated to include these characteristics.

Continued user selection of physical objects may then be used to refine the search query. For example, user selection is detected of another physical object in the physical environment (block 1106). The search query is then refined based on one or more characteristics of the other physical object (block 1108). As shown at the second stage 1004, the hand 1008 of the user is detected as selecting a design 1012 of two hearts included as part of an artwork 1014. Characteristics of the design 1012 are used to further refine the search query, such as to include text of “two hearts,” used as part of a digital image similarity determination without the use of text, and so forth. Thus, these characteristics of the design 1012 and the characteristics of the coffee mug 1010 are used to form the refined search query. This process may continue over additional interactions, such as to select a style of handle, material for the mug (e.g., by selecting a stainless steel surface of a refrigerator), and so forth.

The refined search query is then used as a basis for a search, which may be performed locally by the computing device 102 and/or remotely through use of the search service 130. A result is output of a search performed using the refined search query (block 1110). The result, for instance, may be configured as a conventional search result as displayed on a display device of a mobile phone, desktop computer, and so on. In another instance, the result is formed for display as one or more virtual objects 108 as part of a virtual user experience in an augmented or virtual reality environment as described in relation to FIG. 1.

An example of this is shown at the third stage 1006 in which a search result 1016 is configured as a virtual object 108 of a coffee mug of the first stage 1002 having a design that approximates the selected design 1012 from the second stage 1004. In this way, the user 110 is able to generate and launch a search query 110 without manually inputting text, which may thus overcome conventional difficulties of the user in articulating a desired result.

As previously described in relation to FIG. 1, a bidding process may be incorporated as part of a search performed by the search service 130. For example, the bid manager module 140 may expose functionality via a user interface in which advertisers and other entities may bid on opportunities for inclusion in a search result based on interaction of the user 110 with physical objects. This may include opportunities to bid on types of objects, characteristics of the objects (e.g., red, stainless steel), types of user interactions with the objects (e.g., held versus looked upon over a threshold amount of time), and so forth. This may also include opportunities for how the search results are output, e.g., on a conventional display device versus part of a virtual user experience 106.

Search Refinement Using Object Detection

FIG. 12 depicts a system 1200 and FIG. 13 depicts a procedure 1300 in an example implementation showing operation of the user experience manager module 104 of FIG. 1 as refining a search based on an environmental context. The procedure 1300 may be implemented by a variety of different systems, such as the system 200 of FIG. 2. The system 1200 is illustrated using first, second, third, and fourth stages 1202, 1204, 1206, 1208.

The following discussion describes techniques that may be implemented utilizing the described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 2, 12-13.

As before, a user input is received that defines a text search query (block 1302). The user 110, for instance, may interact with a user input device 202 to provide inputs that are received by a text manager module 204 to form a text search query 206. The text may be received directly or determined indirectly by the text manager module 204. In a direct example, the user 110 inputs the text through use of a user input device 202 configured as a keyboard. In an indirect example, an utterance 110 of the user 110 is converted to text by the text manager module 204, e.g., using speech-to-text functionality.

In this example, user selection is detected of a physical object in a physical environment (block 1304). A search query context for the text search query is then determined based on the one or more characteristics of the physical object (block 1306), which is then used to generate a search query that includes the text search query and the search query context. In this way, user selection of the physical objects may be used to further refine the text search query.

As shown in an example system 1200 of FIG. 12, for instance, a user 110 provides a text input search query, in this case via a spoken utterance of stainless steel refrigerator 1210 at the first stage 1202. In response, the user experience manager module 104 initiates a search for stainless steel refrigerators.

The user 110, in this example, may be disposed in an appliance warehouse and select physical objects in succession, which are then used to further refine the search results. At the second stage 1204, for instance, a user selection is received of an ice maker 1214 by tapping object with a hand 1212 of the user. The user selection of the ice maker 1214 is used as a search query context 218 along with the text search query 206 to perform a search to retrieve refrigerators that include ice makers.

At the third stage 1206, a user selection is received of a handle. The user experience manager module then determines which characteristics of the handle are relevant to the text search query, which in this case is a handle shape 1216. This process may continue through selection of additional physical objects, such as to select a lower drawer as shown at the fourth stage 1208. From this selection of the lower drawer, the user experience manager module 104 infers that the user is interested in refrigerators having that drawer configuration 1218.

In the illustrated example of FIG. 2, the search query formation module 214 forms the search query 216 to include the text search query 206 as well as the determined search query context 218. This is communicated over a network 132 to a search service 130 and used to perform a search. Digital content 136 resulting from the search (e.g., ordered search results, songs, images, and so forth) is communicated back to the user experience manager module 104 via the network 132. A result is then output of a search performed using the search query having the text search query and the search query context (block 1310). The result of the search may be configured in a variety of ways.

In the previous example, a user interface is output having digital content 136 that depicts refrigerators that are available that satisfy the combination of text search query 206 and search query context 218. In the example of the store, the digital content 136 may also include directions to refrigerators that are available at that store, i.e., directions on where in the store these refrigerators are located, other stores, or online Thus, in this example the characteristics of the physical objects are used to further refine the text search query 206.

Example System and Device

FIG. 12 illustrates an example system generally at 1200 that includes an example computing device 1202 that is representative of one or more computing systems and/or devices that may implement the various techniques described herein. This is illustrated through inclusion of the user experience manager module 104. The computing device 1202 may be, for example, a server of a service provider, a device associated with a client (e.g., a client device), an on-chip system, and/or any other suitable computing device or computing system.

The example computing device 1202 as illustrated includes a processing system 1204, one or more computer-readable media 1206, and one or more I/O interface 1208 that are communicatively coupled, one to another. Although not shown, the computing device 1202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that may be configured as processors, functional blocks, and so forth. This may include implementation in hardware as an application specific integrated circuit or other logic device formed using one or more semiconductors. The hardware elements 1210 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1206 is illustrated as including memory/storage 1212. The memory/storage 1212 represents memory/storage capacity associated with one or more computer-readable media. The memory/storage component 1212 may include volatile media (such as random access memory (RAM)) and/or nonvolatile media (such as read only memory (ROM), Flash memory, optical disks, magnetic disks, and so forth). The memory/storage component 1212 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1202. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1202, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1210. The computing device 1202 may be configured to implement particular instructions and/or functions corresponding to the software and/or hardware modules. Accordingly, implementation of a module that is executable by the computing device 1202 as software may be achieved at least partially in hardware, e.g., through use of computer-readable storage media and/or hardware elements 1210 of the processing system 1204. The instructions and/or functions may be executable/operable by one or more articles of manufacture (for example, one or more computing devices 1202 and/or processing systems 1204) to implement techniques, modules, and examples described herein.

The techniques described herein may be supported by various configurations of the computing device 1202 and are not limited to the specific examples of the techniques described herein. This functionality may also be implemented all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 may include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 may abstract resources and functions to connect the computing device 1202 with other computing devices. The platform 1216 may also serve to abstract scaling of resources to provide a corresponding level of scale to encountered demand for the resources 1218 that are implemented via the platform 1216. Accordingly, in an interconnected device embodiment, implementation of functionality described herein may be distributed throughout the system 1200. For example, the functionality may be implemented in part on the computing device 1202 as well as via the platform 1216 that abstracts the functionality of the cloud 1214.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to initiate and output a search, a method implemented by at least one computing device, the method comprising:
detecting, by the at least one computing device, user selection of a physical object in a physical environment of the at least one computing device;
determining, by the at least one computing device, a search query context for the text search query based on one or more characteristics of the physical object;
generating, by the at least one computing device, a search query that includes the text search query and the search query context; and
outputting, by the at least one computing device, a result of a search performed using the search query having the text search query and the search query context.

2. The method as described in claim 1, wherein the user input is manually input by the user or provided via a spoken utterance.

3. The method as described in claim 1, further comprising repeating the detecting, the determining, the generating, and the outputting in response to one or more additional user selections of physical objects that refine the search query context of the test search query.

4. The method as described in claim 1, wherein the one or more characteristics define a type of the object.

5. The method as described in claim 1, wherein the one or more characteristics define a color, texture, or shape of the object.

6. In a digital medium environment to initiate and output a search, a method implemented by at least one computing device, the method comprising:
receiving, by at least one computing device, a user input defining a text search query;
detecting, by the at least one computing device, one or more environmental conditions of a physical environment of the at least one computing device;
determining, by the at least one computing device, a search query context for the text search query based on the one or more environmental conditions;
generating, by the at least one computing device, a search query that includes the text search query and the search query context; and
outputting, by the at least one computing device, a result of a search performed using the search query having the text search query and the search query context.

7. The method as described in claim 6, wherein the one or more environmental conditions of the physical environment describe at least one object disposed in the physical environment.

8. The method as described in claim 7, wherein the one or more environmental conditions also describe at least one characteristic of the at least one object.

9. The method as described in claim 8, wherein the at least one characteristic is a color, a number of the at least one object present, or brand of the object.

10. The method as described in claim 6, wherein the one or more environmental conditions of the physical environment describe a room type of the physical environment.

11. The method as described in claim 6, wherein the one or more environmental conditions describe whether the physical environment is likely part of a home or work environment.

12. The method as described in claim 6, wherein the detecting is performed in response to the receiving of the user input of the text search query.

13. The method as described in claim 6, further comprising transmitting the search query over a network to a search service and receiving the result from the search service via the network.

14. The method as described in claim 6, further comprising searching one or more items of digital content stored locally by the at least one computing device and wherein the result is formed based on the searching.

15. In a digital medium environment to initiate and output a search, a system comprising:
an object detection module implemented at least partially in hardware of a computing device to detect a type of object in an image of a physical environment, in which, the computing device is disposed; and
an application launch module implemented at least partially in hardware of a computing device to:
identify an application that corresponds to the detected type of object; and
launch the identified application for execution by the computing device.

16. The system as described in claim 15, further comprising a user interaction detection module implementation at least partially in hardware of the computing device to detect user interaction with the object in the physical environment and wherein the detecting of the type of object is performed by the object detection module in response to the detected user interaction.

17. The system as described in claim 16, wherein the detecting of the user interaction includes recognizing that a user has likely gazed at the object over a threshold amount of time.

18. The system as described in claim 16, wherein the detecting of the user interaction includes recognizing that a user has performed a gesture.

19. The system as described in claim 18, wherein the application launch module is further configured to initiate an operation of the identified application that corresponds to the recognized gesture.

20. The system as described in claim 15, wherein the object is incapable of transmitting data to the computing device.
